(19) United States
(12) Patent Application Publication
(10) Pub. No.: US 2009/0171866 A1
(43) Pub. Date: Jul. 2, 2009

(54) System and method for learning associations between logical objects and determining relevance based upon user activity

(76) Inventors: Toufique Harun, (US); Daniel Kaplan, (US); Khalid Harun, (US); Rashed Harun, (US); Catherine Lachance, (US)

Correspondence Address: ELMAN TECHNOLOGY LAW, P.C., P. O. BOX 209, SWARTHMORE, PA, 19081, US

(21) Appl. No.: 11/831,351

(22) Filed: Jul. 31, 2007

Related U.S. Application Data
(60) Provisional application No. 60/820,882, filed on Jul. 31, 2006.

(51) Int. Cl. G06F 15/18; G06F 17/30

(52) U.S. Cl. 706/12; 707/E17.055; 707/103 R

(57) ABSTRACT

User activity streams are used to automatically learn associations between logical objects and form logical groups. Search results are sorted based upon their relevance to current user activity. Combined with a graphical user interface component and object database, the invention automatically retrieves and display groups and objects related to the active object.

### CROSS REFERENCE TO RELATED APPLICATIONS

This application claims the benefit under 35 U.S.C. 119(e) from U.S. Provisional application 60/820,882, filed Jul. 31, 2006, the entire contents of which are incorporated herein by reference.

### FIELD OF INVENTION

The present invention relates to information organization and retrieval methods and systems, and more particularly, to a method for automatically learning associations between logical objects based upon the sequence of activity upon said objects, a method for determining relevance and a system for implicitly retrieving and displaying information relevant to current user activity.

### BACKGROUND

We live in an age where information overload is a huge problem. Immediately relevant information is frequently not easily accessible or takes too long to retrieve because it is hidden among a larger corpus of irrelevant information. The challenge of giving people the right information at the right time is one that we have to overcome to solve the information overload crisis.

People have tried to solve this problem in two major ways: organization and search. Organization involves classifying information into related clusters and hierarchies. Examples of these are directory-based file organizers, web site directories, gopher, tables of contents, etc. In order to retrieve organized information, users must know the proper classification of the information they are looking for and browse through the hierarchy and clusters to find that information. Retrieval fails if the information is classified improperly or, as is the case with the vast majority of information, not classified at all. These are frequent occurrences because manual organization is required to create the initial clusters and hierarchies.

To combat the impracticality of manual organization, search methods were devised. Search methods index information by their content and characteristics. They allow users to run ad hoc queries to retrieve matching results. Examples of search include search engines, desktop search tools, etc. However, search requires users to guess the content and characteristics of the information they are looking for and construct queries that hopefully capture those characteristics. It is a crude hit- or- miss method of retrieving information with very high false positive and false negative rates. In addition, it does not address the need to organize information into related clusters and hierarchies of information at all.

A recent innovation in search that mitigates the need to actively search for information is implicit query. Implicit query methods track user activity to determine active objects and extract prominent keywords from them. These keywords are subsequently fed into search engines and the retrieved results displayed. In reality, all this accomplishes is speed up the retrieval of the high false positive and false negative laden results retrieved from search engines. While implicit query methods also track and log user activity, they have only used that data to present unprocessed usage history dumps to allow users to retrace their steps and not much more than that.

All of these methods require manual intervention from the user in organizing, searching, retrieving, and determining the relevance of information. Ideally, users should not have to manually organize information, nor should they have to actively look for it. It should automatically be organized for them and presented to them when relevant and only when relevant. Information organization and retrieval technology is clearly not at that point today. Thus there is clearly a need for better information organization and retrieval systems.

### SUMMARY OF THE INVENTION

The present invention solves a fundamental problem of information organization by automatically learning associations between logical objects based, at least in part, upon the history of activity upon said objects. This method of evidence-based learning makes clustering logical objects into logical groups much easier than doing so by processing the content and characteristics of the objects. This method is also a more accurate method of clustering because it determines associations based upon relevance as evidenced by the activity of the content users and not just the content and metadata input by the content authors, which are often intentionally misleading. In addition, the activity data provides more data points and are self-correcting over time.

This method and system further enables the invention to automatically predict the information needs of users based upon current user activity and automatically retrieve and display related objects and perform related actions thereby eliminating the need for manual search and retrieval.

The method and system further enables the invention to process a set of logical objects and sort them based upon their relevance to the current user activity.

In a networked embodiment of the invention, the method allows the determination of object associations to be based upon the collective activity of multiple users on multiple computers systems.

The features and advantages described in the specification are not all inclusive and, in particular, many additional features and advantages will be apparent to one of ordinary skill in the art in view of the drawings and specification of this disclosure. Moreover, it should be noted that the language used in the specification has been principally selected for readability and instructional purposes, and may not have been selected to delineate or circumscribe the inventive subject matter.

### ASPECTS OF THE INVENTION

In one aspect of the invention, the invention provides a method for associating logical objects based on the user activity upon the logical objects.

In one aspect of the invention, the invention provides a method for associating logical objects based on temporal proximity of activation and deactivation of the logical objects.

In another aspect of the invention, when a logical object is activated, associated logical objects are also activated automatically.

In another aspect of the invention, when a logical object is activated, associated logical objects are presented in to a user via a user interface.

In another aspect of the invention, a pinning operation creates a permanent association between two logical objects.

In another aspect of the invention, a blacklisting operation creates a permanent disassociation between two logical objects.

In another aspect of the invention, when a first logical object is activated and a second logical object is subsequently activated within a predetermined time interval, a strong association between the first object and second object is stored in a database.

In another aspect of the invention, when a first logical object is activated and a second logical object is subsequently deactivated within a predetermined time interval, a weak disassociation between the first object and second object is stored in a database.

In another aspect of the invention, when a first logical object is deactivated and a second logical object is subsequently activated within a predetermined time interval, a strong disassociation between the first object and second object is stored in a database.

In another aspect of the invention, when a first logical object is deactivated and a second logical object is subsequently deactivated within a predetermined time interval, a weak association between the first object and second object is stored in a database.

In another aspect of the invention, a means for associating logical objects based on temporal proximity of activation and deactivation of the logical objects resides on a central device on a communications network, and receives user activity information from remote devices on the communications network.

In another aspect of the invention, a means for associating logical objects based on temporal proximity of activation and deactivation of the logical objects resides on multiple devices on a communications network, and stores association data on a central device on the communications network.

In another aspect of the invention, a given set of logical objects are sorted by sorting the association strengths between the logical objects in the set and the most recent objects in the user activity stream.

In another aspect of the invention, temporal analysis is applied to a first list of logical objects, such as a resultant set from a keyword-based search, the most recently used logical objects being presented in a user interface, and a second list of associated logical objects based on temporal proximity of activation and deactivation of the first logical objects is also presented on the user interface.

In another aspect of the invention, a logical group, referred to as a tag, is established. The tag contains a collection of logical objects. The logical objects are periodically reevaluated to determine if they should remain in the tag. The reevaluation criteria is based on the association value of the logical objects.

In another aspect of the invention, a logical object that does not belong to a particular tag is evaluated to see if it should be included in that tag. This logical object is referred to as an “outsider” logical object. The evaluation criteria is based on the association value of the “outsider” logical object.

### BRIEF DESCRIPTION OF THE DRAWINGS

FIG. 1 is a block diagram illustrating an exemplary environment in which one embodiment of the present invention may operate.

FIG. 2 is a block diagram illustrating an exemplary computer network environment in which the present invention may be practiced.

FIG. 3 is an exemplary graphical user interface in accordance with an aspect of the present invention

FIG. 4 is a diagram illustrating an exemplary environment in which a networked activity stream variation of the present invention may operate.

FIG. 5 is a diagram illustrating an exemplary environment in which a networked collective learning variation of the present invention may operate.

FIGS. 6-12 are flowcharts depicting an embodiment of the method of the present invention.

FIG. 13 is a flowchart depicting an integrated desktop search embodiment.

FIG. 14 is an exemplary user interface of an integrated desktop search environment.

FIG. 15 shows another exemplary user interface.

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the invention.

### DETAILED DESCRIPTION

The following detailed description of the invention refers to the accompanying drawings. The following detailed description does not limit the invention.

### DEFINITIONS

As the term is used herein, “learning associations” is to be broadly interpreted as inferring relationships between objects based upon a set of data inputs.

As the term is used herein, “activity stream” of an object is to be broadly interpreted as the data describing the sequence of activities upon said object. For example, learning associations between logical object based upon the activity stream refers to the inferring of relationships between logical objects by processing the data describing the sequence of activities performed upon said logical objects.

As the term is used herein, “temporal proximity” is to be broadly interpreted as the juxtaposition of two events in time as well as the elapsed time between the former event and the latter event. The term “temporal analysis” involves determination of if two logical objects had activity, including activations and/or deactivations, occurring within temporal proximity, in accordance with the method of the present invention.

As the term is used herein, a “logical object” is to be broadly interpreted to include any information representable in a machine-readable format. Examples of logical objects may include but are not limited to documents, emails, files, folders, applications, pictures, web pages, web sites, links, bookmarks, contacts, appointments, tasks, events, announcements, news, blog entries, RSS feeds, chat conversations, words, sentences, document sections, text and data elements and fragments, metadata, equations and transformations, charts, menu items, choices, actions, locations, goods for sale, advertisements, logical groups, etc.

As the term is used herein, a “logical group” is to be broadly interpreted to mean a collection of logical objects. Examples of logical groups may include, but are not limited to, projects, folders, tags, topics, people, days, locations, etc.

A logical group may comprise other logical groups, thereby allowing hierarchical organization, e.g. computer folders. A logical object can also be a reference to another logical object, e.g. hyperlinks. A logical object can contain other embedded logical objects, e.g. pictures contained within documents. A logical object can also refer to a portion of another logical object, e.g. anchor hyperlinks. It is also possible for an entity of information to correspond to a plurality of logical objects, e.g. an e-mail can also correspond to its senders and recipients.

As the term is used herein, a “logical location” is to be broadly interpreted to include any machine-representable address where logical objects may be stored and retrieved. Examples of logical objects may include but are not limited to a computer directory, a shared repository, a shared calendar, a directory on a server, a computer on a peer-to-peer network, a picture sharing site, a tagging database, an e-mail address, etc.

One embodiment of the learning method of the invention applies the Hebbian learning principle of “fire together, wire together” to the history of user activity or the activity stream. Objects that are activated simultaneously or in close temporal proximity are inferred to be related. Their association strengths are increased appropriately. In addition, a decay of the association strengths can be used to purge false and weak associations and self-correct the associations. In one embodiment, the association strength may be represented as a numeric value, referred to as an association value. As associations occur, the value is incremented, and the value is decremented as disassociations occur. Strong associations cause a larger increment to the association value than do weak associations. Similarly, strong disassociations cause a larger decrement than do weak disassociations. This mechanism effectively forgets unused associations and makes the groupings more accurate over time.

One embodiment of the learning engine maintains an association matrix, which is an N×N matrix containing the association strengths between N logical objects. As the notation is used herein, M[A, B] refers to the association strength between objects A and B in association matrix M. Objects associated with an object A can be retrieved by finding M[A, x] over the entire range of x and returning the entries with the largest association strengths or the entries with association strengths above a predetermined threshold value.

This particular embodiment of the method receives activity stream data from one or more activity tracking systems residing in one or more computers systems. The activity stream data is then filtered be activity type. This particular embodiment categorizes activities into three main categories: activations, deactivations, and commands to the learning engine. Examples of activations may include but are not limited to:
Typing into, opening, selecting, focusing upon, scrolling inside, switching between, maximizing, resizing or moving windows.
Selecting, cutting, copying, pasting, dragging, or dropping text, graphics or other graphical user interface objects.
Pressing, clicking, or double clicking buttons, icons or links.
Performing an action involving a logical object. For example, sending an e-mail to an e-mail contact is an activation of the contact.

Examples of deactivations may include but are not limited to closing, minimizing, or removing focus from windows. Examples of commands may include but are not limited to adding, removing, updating, or changing the logical locations of logical objects, for instance, moving files.

This particular embodiment updates the association matrix based upon the activity stream data. As used herein, the most recent activity event is referred to as the “post-event,” and the activity event immediately preceding the post-event is referred to as the “pre-event.”

Upon receiving activity event data, this embodiment determines the objects associated with the pre-event and the post-event. If either object is not included in the association matrix, the missing object is added to the matrix. The association strengths between the two objects are updated according to the update rules in TABLE 1.

TABLE 1

| Pre-Event | Post-Event | Update Rule |
|---|---|---|
| Activation | Activation | Strong associate |
| Activation | Deactivation | Weak disassociate |
| Deactivation | Activation | Strong disassociate |
| Deactivation | Deactivation | Weak associate |

If an activation is followed by an activation, the objects are inferred to be related. Therefore, this method strongly associates the objects by increasing the association strength between them by a constant.

If a deactivation is followed by an activation, the objects are inferred to be unrelated. Therefore, this method strongly disassociates the objects by decreasing the association strength between them by a constant.

An activation followed by a deactivation results in a weak disassociation, and a deactivation followed by a deactivation results in a weak association. The difference between a weak and a strong update is that the weak updates use a smaller constant to update the association strengths.

A variation of the embodiment uses asymmetric update constants in order to give preference to associations. Another variation updates the association strengths using values inversely proportional to the temporal proximity of the pre-event and the post-event instead of constants.

Yet another variation uses the history of activity in addition to the latest activity events to update association strengths. Some objects may be used more frequently than others. One embodiment keeps a record of the historical activity stream data for each object and corrects deviations by comparing the historical data to the current data. For example, one embodiment uses association strength update values proportional to the difference between the historical average activation frequency and the instantaneous activation frequency. This allows the learning engine to rectify skewing of associations due to the heterogeneity of activity frequency.

Another aspect of the invention purges unused associations using a mechanism similar to forgetting. When objects in a group or the short term memory component are used, the association strengths of the unused objects are globally decreased. This refines the object associations over time and decreases the false positive rates.

Yet another aspect of the invention allows users to manually fine-tune object associations by adding, removing, pinning and blacklisting objects from logical groups. Pinning refers to permanently associating an object with a group such that it will not be automatically forgotten from the group. Blacklisting refers to putting the object on a list of ignored objects such that it will not be automatically associated with groups or objects. The association strengths of blacklisted or pinned objects are not affected by any future activity upon said objects unless the blacklisting or pinning is reversed. Further manual fine-tuning includes, tagging (associating one or more keywords) with the objects and groups.

Another aspect of the invention optimizes learning by making assumptions based upon the object type. For instance, if an e-mail is sent from an e-mail contact, that e-mail and the contact are inferred to be associated.

Yet another aspect of the invention facilitates collective learning by merging associations learnt from user activity streams on one or more machines by performing a union on the set of individual associations. This enables the coalescing of learning done by one user on multiple machines, multiple users on the same machine, and multiple users on multiple machines.

Yet another aspect of the invention integrates the association methods of the present invention with a keyword-based desktop search engine. While desktop search engines are recognized by those skilled in the art as utilities to search the contents stored on a particular “local” computer, it will be recognized that the search may take place across multiple machines without departing from the scope of the present invention.

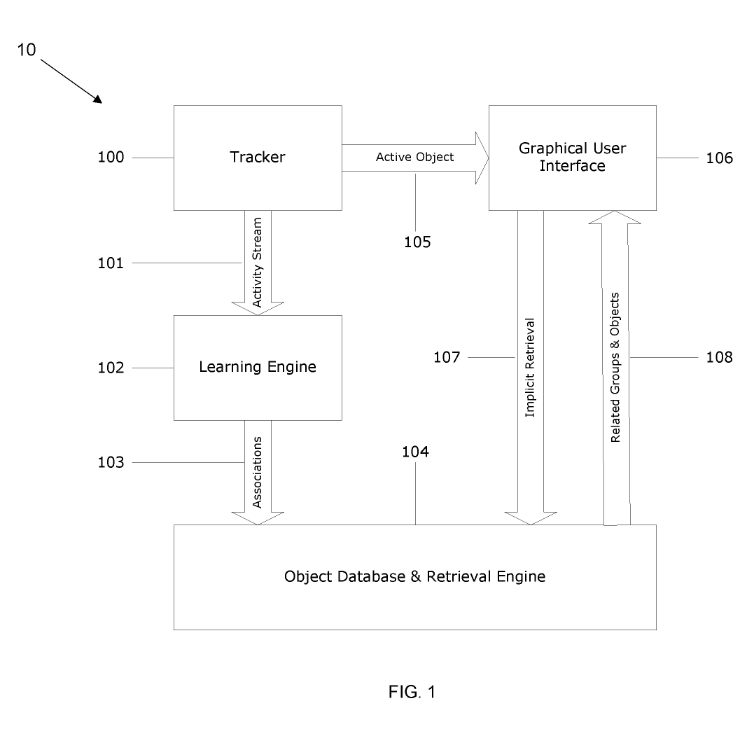

One embodiment (FIG. 1) of the system (10) of invention comprises a tracker component (100), a learning engine (102) employing the learning method above, an object database and retrieval engine (104), and a graphical user interface (106).

The tracker component (100) tracks user activity upon logical objects. The tracker component may comprise machine readable code attached to relevant applications to record activity data. This particular embodiment uses add-ins for software applications, such as word processors and spreadsheets, to detect user activity. These add-ins call a central event listener from the event handlers of desired events. Another embodiment of the tracker tracks events upon logical objects that are accessed by web applications. Examples of these web applications can include online e-mail access applications, calendars, word processors, spreadsheets, etc. The tracker component may also be built into the applications, whether local or web-based, or into the operating system.

The captured activity stream (101) is then reported to the learning engine component (102). The learning engine component (102) determines associations (103) between logical objects and groups objects into logical groups based upon the activity stream data.

The associations between logical objects and groups are stored in an object database and retrieval engine component (104). This component can be manifested as a relational database, an object-oriented database, an XML database or file, directory services, associative memory, or any other mechanism that allows storage and retrieval of hierarchical data and associations. This component allows the retrieval related groups and objects (108). It may also retrieve and sort results by frequency of use, relevance, most recently used, and user preference. The results may be further refined by factoring in the strengths of their associations with the most recently activated objects. The results can also be exposed as XML, thereby enabling easy interfacing with other software, especially software that facilitate searching and retrieval of information.

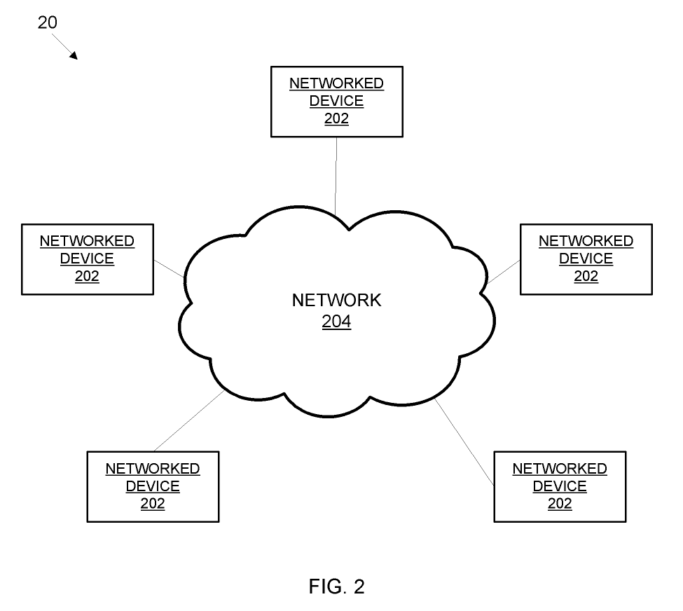

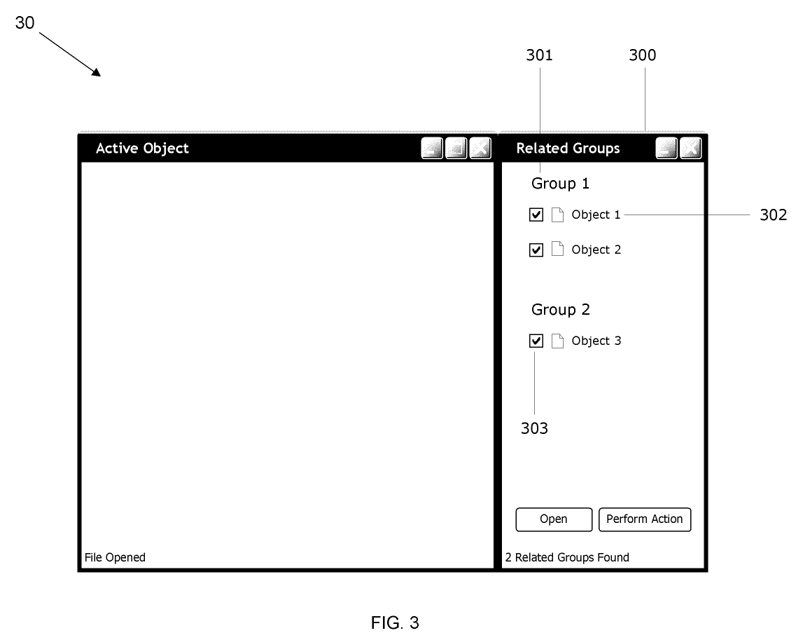

The activity stream (101) and the active object (105) are also reported to the graphical user interface (GUI) component (106), which performs implicit retrieval (107) and related displays objects and groups (108) that are related to the active object (105). FIG. 2 shows an exemplary computer network (20) in which the present invention may be practiced. It is noted that the present invention may be employed on a single “non-networked” device, or a networked environment as shown in FIG. 2. In FIG. 2, a plurality of networked devices 202 are shown. These devices may include, but are not limited to, desktop computers, laptop computers, mobile devices, cell phones, and PDAs. The network 204 may be a wide area network, such as the Internet, or a local area network. It may be implemented with a combination of wired and wireless connectivity. Referring to FIG. 3, the GUI component (30) comprises a sidebar interface (300) that displays one or more groups (301) and the objects (302) contained within those groups. The display can be made non-obtrusive by disappearing after a few seconds or being semi-transparent. The strength of the associations can be displayed by using transparency, contrast, and the relative positioning of the icons representing the logical objects.

The GUI component (30) can also allow the user to manually fine-tune associations and groupings. For example, a user can drag and drop objects into and out of groups. Users can also add, remove, pin, blacklist, or tag objects and groups. In addition to retrieving and displaying related objects, the GUI component (30) can also automatically perform other actions related to the active object such as opening a related application or preloading a related web page. Additionally, the related actions can be automatically determined by analyzing the history of activity.

The GUI component (30) can also be used to perform batch actions upon related objects. The related objects can be selected automatically or by active selection, for example, by juxtaposing selection checkboxes (303) next to object icons. Examples of batch actions are to move, copy, share or send related objects to one or more logical locations. These batch actions can be used to easily organize related logical objects into folders, share them with other users, or tag them in a tagging database.

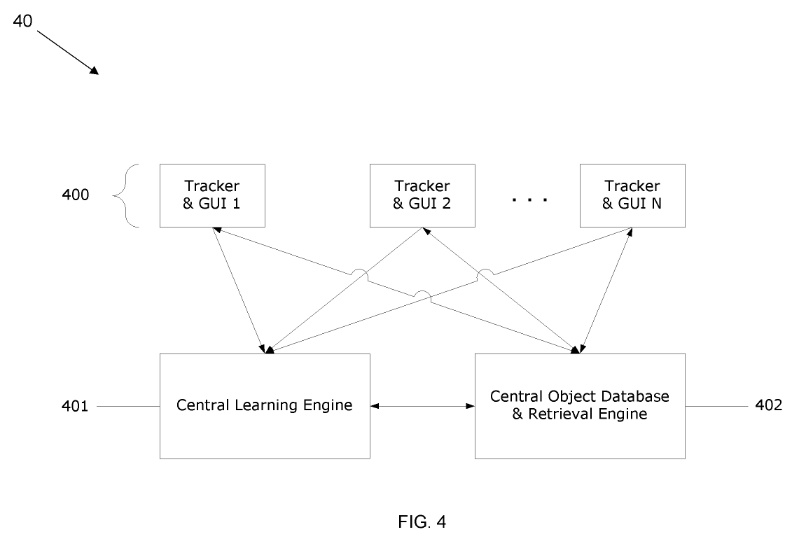

While the system shown in FIG. 1 reflects one embodiment of the invention, other embodiments are possible as well. One such embodiment is a networked variation of the system in which each of the components of the system may be distributed over several systems. In addition, the networked system may comprise a plurality of each component. FIG. 4 shows a centralized learning configuration (40) that is comprised of several tracker components (400), each residing on a different user's machine reporting activity data to a central learning engine (401). This configuration can be used to construct a user activity stream system, whereby the activities of multiple users can be reported and analyzed to create shared logical groups that are stored in the Central Object Database and Retrieval Engine component (402).

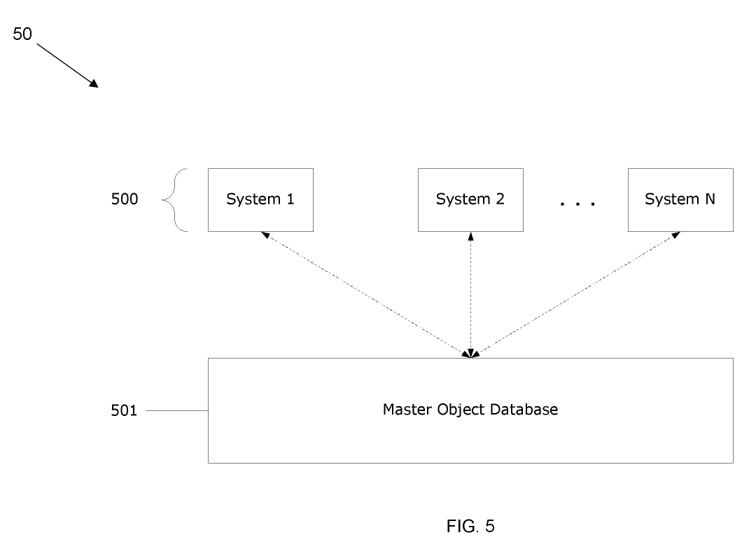

FIG. 5 shows a distributed learning configuration (50) that is comprised of several systems (500), each system 500 feeding their object hierarchies into one or more master object databases (501) to create shared logical groups. Each system 500 is similar to system (10) shown in FIG. 1. The master databases can merge the associations learnt in each of the individual systems to form a collective understanding of the groupings on intranets or the Internet. An advantage of this configuration is that it does not require each independent system to be constantly and synchronously connected to the central system. The collective understanding can be created and retrieved asynchronously and in a semi-connected mode.

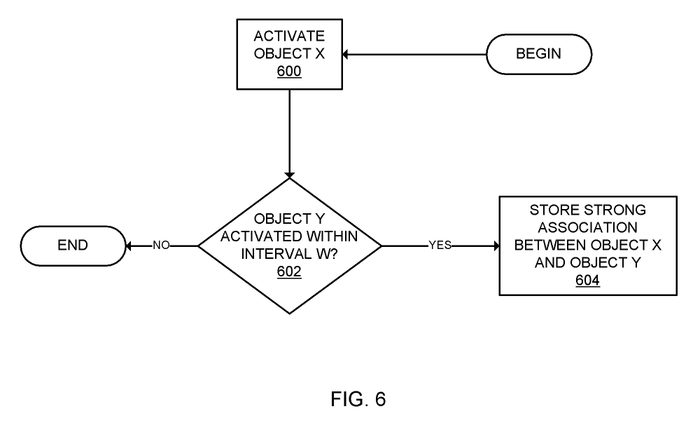

FIGS. 6-11 are flowcharts depicting an embodiment of the method of the present invention. Referring now to FIG. 6, an object X is activated in step 600. In one embodiment, the activation occurs when a document is opened. A predetermined time window (or interval) W is a time interval that is used in evaluating associations. In an exemplary embodiment, the time window W is 30 seconds. However, other values of W may be used. The value of W may also be dynamic, and configurable by the user. At step 602, an object Y is activated in a similar manner as was object X. A check is made to see if the activation of object Y occurred within time window W, and if so, a strong association is established between object X and object Y in step 604. This strong association is stored in object database 104 (FIG. 1).

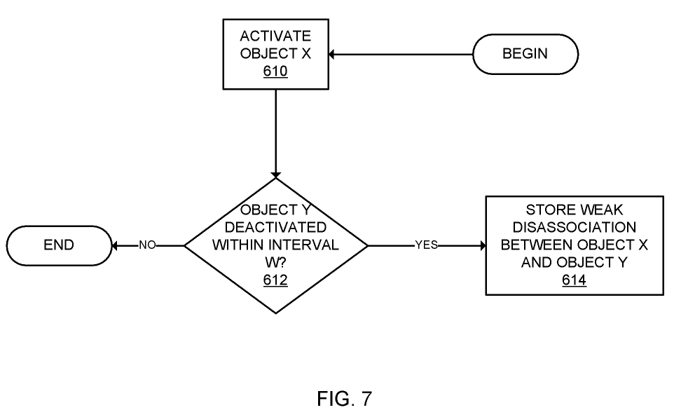

FIG. 7 shows the flow of a weak disassociation. An object X is activated in step 610. At step 612, an object Y is deactivated. In one embodiment, the deactivation occurs when a document is closed. A check is made to see if the deactivation of object Y occurred within time window W, and if so, a weak disassociation is established between object X and object Y in step 614. This weak disassociation is stored in object database 104 (FIG. 1).

FIG. 8 shows the flow of a strong disassociation. An object X is deactivated in step 620. At step 622, an object Y is activated. A check is made to see if the activation of object Y occurred within time window W, and if so, a strong disassociation is established between object X and object Y in step 624. This strong disassociation is stored in object database 104 (FIG. 1).

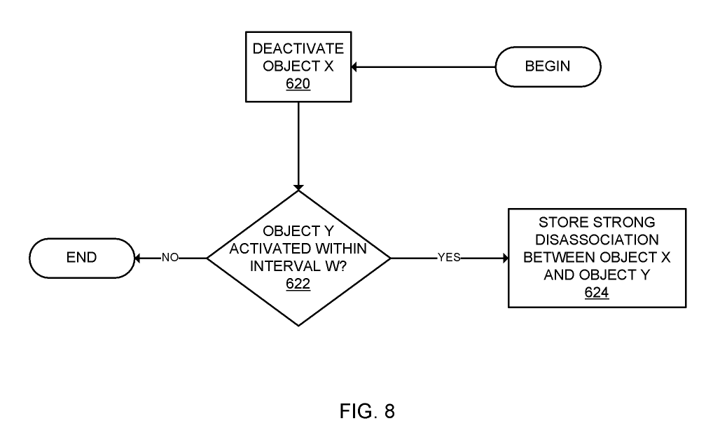

FIG. 9 shows the flow of a weak association. An object X is deactivated in step 630. At step 632, an object Y is deactivated. A check is made to see if the deactivation of object Y occurred within time window W, and if so, a weak association is established between object X and object Y in step 634. This weak association is stored in object database 104 (FIG. 1).

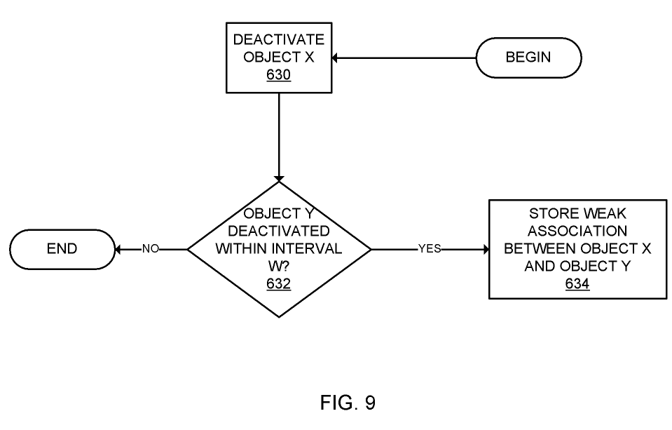

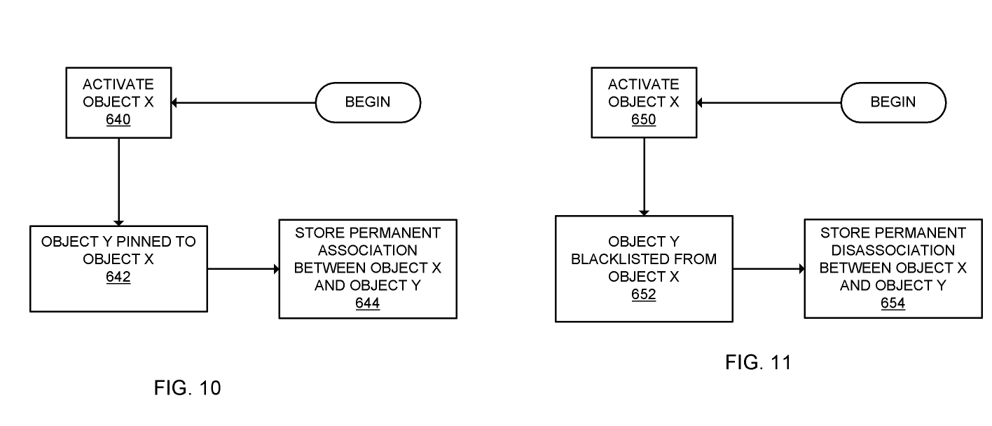

FIG. 10 shows the flow of a pinning operation. An object X is activated in step 640. At step 642, an object Y is “pinned” to object X. The pinning operation causes a permanent association between object X and object Y in step 644. This permanent association is stored in object database 104 (FIG. 1).

FIG. 11 shows the flow of a blacklisting operation. An object X is activated in step 650. At step 652, an object Y is “blacklisted” from object X. The blacklisting operation causes a permanent disassociation between object X and object Y in step 654. This permanent disassociation is stored in object database 104 (FIG. 1).

The blacklisting and pinning operations are important features of the present invention that allow the user to customize the logical groups, and avoid false associations or false disassociations by overriding the automatic algorithm with manual control.

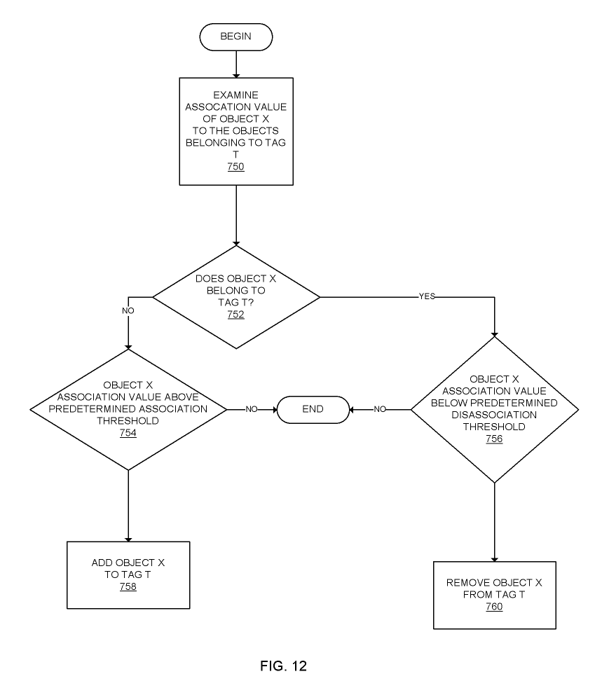

FIG. 12 is a flowchart depicting the management of logical groups or “tags.” In the context of the present invention, the tag is a dynamic logical group, containing logical objects therein. As per the present invention, logical objects enter and exit the tag, based on user activity, or lack thereof. In step 750, the association value of object X is compared to the logical objects that currently belong to tag T. At step 752, a check is made to see if object x currently belongs to tag T. If so, then the object X association value is compared to a predetermined disassociation threshold in step 756. If the object X association value is below the predetermined disassociation threshold, then the object X is removed from tag T. If the object X does not belong to tag T, then the object X association value is compared to a predetermined association threshold in step 754. If the object X association value is above the predetermined association threshold, then the object X is added to tag T. Note that the operation depicted in FIG. 12 may be implemented as a recurring background process that occurs transparently to the user.

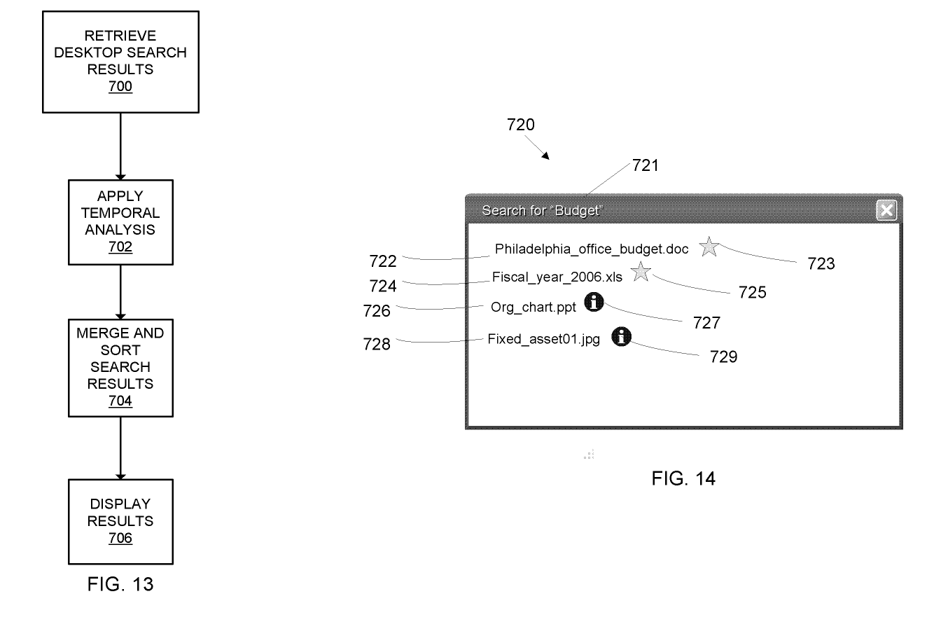

FIG. 13 is a flowchart depicting an integrated desktop search embodiment. In step 700, a set of logical objects, such as a resultant set of files from a standard “keyword based” search, is retrieved. In step 702, the temporal analysis of each logical object retrieved from the keyword search is performed, causing other logical objects to be retrieved. In step 704, the keyword search results and temporal search results are merged and sorted by relevance as determined by the methods in this invention. In step 706 the results are displayed to the user. The keyword based search results are sorted based on recent usage. Other objects (e.g. files) that were used in temporal proximity are also displayed.

FIG. 14 shows an exemplary user interface 720. In this example, the keyword (721) used for the search was “budget.” Four results (722, 724, 726, and 728) are shown. Each result is accompanied by a graphical indication (723, 725, 727, and 729). In this embodiment, the graphical indication indicates the source of the retrieval. For example, the first two files, “Philadelphia_office_budget.doc” (722) and “Fiscal_year_{—}2006.xls” each have a star icon (723 and 725 respectively) associated with them. The star icon (723,725) indicates that these files were retrieved via the keyword search. The other two files, “Org_chart.ppt” (726) and “Fixed_asset01.jpg” (728) have an “i” icon (727 and 729, respectively) associated with them. The “i” icon (727, 729) indicates that these files were retrieved based on temporal proximity to one or both of the first two files, “Philadelphia_office_budget.doc” (722) and “Fiscal_year_{—}2006.xls” (724). In other words, the word “budget” does not appear in the latter two files “Org_chart.ppt” (726) and “Fixed_asset01.jpg” (728). Yet, they were retrieved because they belong to the logical group of the first two files (722 and 724). In this example, “Fixed_asset01.jpg” (728) is presumably a file of a fixed asset item used in budget preparation. Since “Fixed_asset01.jpg” (728) is not a text file, and presumably contains no context based keywords indicating relevance to a budget, searching via the keyword “budget” would not have retrieved this file. Yet, by using the method of the present invention, the relevant data file “Fixed_asset01.jpg” (728) is retrieved. This example illustrates the utility of the method of the present invention.

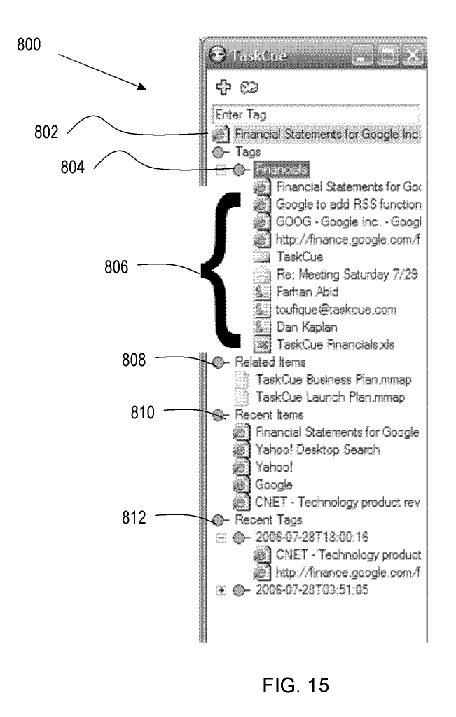

FIG. 15 shows another exemplary user interface 800. Those skilled in the art will recognize that the user interface 800 may be implemented as a standalone application. Alternatively, the user interface 800 may be implemented as a plugin without departing from the scope of the present invention. In this embodiment, the user interface 800 indicates an active logical object 802. Tags that object 802 belongs to are shown below. In this example, a tag “Financials” indicated as 804 is shown. The list of objects 806 belonging to tag 804 may be viewed by the user. Related items 808 are also provided to the users. Items 808 may not belong to a specific tag, but have been identified as relevant based on the method of the present invention described herein. Recent user activity is also provided to the user. A list of recent items 810 shows the user which objects were recently activated. A list of recent tags 812 shows the user what tags were recently activated or accessed.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined within this disclosure. Other embodiments and applications that are apparent to those of ordinary skill in the art, including embodiments which do not provide all of the features and advantages set forth herein, are also within the scope of this invention.

1. A method by which one or more computer systems learn associations between logical objects based upon user activity, comprising:
tracking a history of user activity upon logical objects;
forming correlations or association values between various logical objects; and
ranking the correlations using a scoring algorithm to provide an indication of how likely it is that two logical objects are coupled or related;
wherein logical objects are various files or web pages accessed by one or more computers, such as media, text, e-mails and data files, wherein user activity upon logical objects includes activation and deactivation of logical objects, wherein activation of a logical object includes opening, browsing to, editing, and/or executing the logical object, and wherein deactivation includes closing, minimizing, deleting and/or halting the logical object.

2. The method of claim 1, wherein the correlation between logical objects is calculated based on temporal proximity between activation and deactivation of logical objects.

3. The method of claim 1, further comprising:
activating associated logical objects in response to activation of a logical object.

4. The method of claim 1, further comprising:
presenting on a display associated logical objects in response to activation of a logical object.

5. The method of claim 1, wherein when a first logical object is activated and a second logical object is subsequently activated, a strong correlation is formed between the first logical object and the second logical object.

6. The method of claim 1, wherein when a first logical object is activated and a second logical object is subsequently deactivated, a weak negative correlation is formed between the first logical object and the second logical object.

7. The method of claim 1, wherein when a first logical object is deactivated and a second logical object is subsequently activated, a strong negative correlation is formed between the first logical object and the second logical object.

8. The method of claim 1, wherein when a first logical object is deactivated and a second logical object is subsequently deactivated, a weak correlation is formed between the first logical object and the second logical object.

9. The method of claim 1, wherein a given set of logical objects, such as from a keyword-based search, is sorted by sorting the correlation strengths between the logical objects in the set and logical objects most recent in the tracked activation and deactivation history.

10. The method of claim 1, wherein logical objects are organized and operated on in groups.

11. The method of claim 10, further comprising:
periodically reevaluating the association values of logical objects within a group to determine whether the logical objects should remain in the group.

12. The method of claim 10, further comprising:
evaluating the association value of a logical object not within a group to determine if it should be included in the group.

13. A computer-implemented system configured to learn associations between logical objects based upon user activity, comprising:
means for tracking a history of user activity upon logical objects;
means for forming correlations or association values between various logical objects; and
means for ranking the correlations using a scoring algorithm to provide an indication of how likely it is that two logical objects are coupled or related;
wherein logical objects are various files or web pages accessed by one or more computers, such as media, text, e-mails and data files, wherein user activity upon logical objects includes activation and deactivation of logical objects, wherein activation of a logical object includes opening, browsing to, editing, and/or executing the logical object, and wherein deactivation includes closing, minimizing, deleting and/or halting the logical object.

14. The system of claim 13, wherein the correlation between logical objects is calculated based on temporal proximity between activation and deactivation of logical objects.

15. The system of claim 13, further comprising:
means for activating associated logical objects in response to activation of a logical object.

16. The method of claim 13, further comprising:
means for presenting on a display associated logical objects in response to activation of a logical object.

17. The system of claim 13, wherein logical objects are organized and operated on in groups.

18. The system of claim 17, further comprising:
periodically reevaluating the association values of logical objects within a group to determine whether the logical objects should remain in the group.

19. The system of claim 17, further comprising:
evaluating the association value of a logical object not within a group to determine if it should be included in the group.

20. The system of claim 13, wherein the means for tracking the history of user activity upon logical objects are located on remote devices on a communications network and transmit user activity information to a central device on said communications network, said central device containing the means for forming correlations or association values between various logical objects and the means for ranking the correlations using a scoring algorithm to provide an indication of how likely it is that two logical objects are coupled or related.
